(19) United States
(12) Patent Application Publication
(10) Pub. No.: US 2026/0177857 A1
(43) Pub. Date: Jun. 25, 2026

(54) LIQUID CRYSTAL DISPLAY DEVICE

(71) Applicant: Sharp Kabushiki Kaisha, Osaka (JP)

(72) Inventor: Shinji SHIMADA, Sakai City (JP)

(21) Appl. No.: 19/428,923

(22) Filed: Dec. 22, 2025

(30) Foreign Application Priority Data
Dec. 25, 2024 (JP) 2024-229210

(51) Int. Cl. G02F 1/1335; G02F 1/1333; G02F 1/1337; G02F 1/1343

(52) U.S. Cl. CPC G02F 1/133528; G02F 1/133345; G02F 1/133512; G02F 1/1337; G02F 1/134309

(57) ABSTRACT

A liquid crystal display device having a plurality of picture elements arranged in a matrix including a plurality of rows and a plurality of columns includes a first substrate, a liquid crystal layer, and a second substrate The first substrate includes a first electrode, an insulating layer, and a second electrode in which elongated openings extending along a row direction or a column direction of the plurality of picture elements are provided separately for each of the picture elements. The first substrate further includes a plurality of non-linear elements placed separately in correspondence with each of the picture elements. The liquid crystal layer contains liquid crystal molecules and a chiral dopant. In a plan view, an alignment direction of the liquid crystal molecules beside the first substrate in absence of application of a voltage is placed parallel or orthogonal to a longitudinal direction of the openings.

### BACKGROUND

### 1. Field

The present disclosure relates to a liquid crystal display device.

### 2. Description of the Related Art

In general, liquid crystal display devices are configured by a liquid crystal layer being sealed in between a pair of substrates and are widely used in various applications by taking advantages such as low profiles, light weights, and low power consumption. For example, Japanese Unexamined Patent Application Publication No. 2011-90278 discloses a liquid crystal display device configured such that a liquid crystal layer placed between a pair of substrates contains a liquid crystalline compound and a predetermined concentration of chiral dopant. Further, Japanese Unexamined Patent Application Publication No. 2009-222829 discloses a liquid crystal display device configured such that a liquid crystal layer sandwiched between a pair of substrates has added thereto a chiral agent that causes liquid crystal molecules to rotate in the same direction as that in which the liquid crystal molecules rotate when an electric field is generated between band electrodes and a second electrode.

It is desirable to provide a liquid crystal display device of high display quality.

### SUMMARY

According to an aspect of the disclosure, there is provided a liquid crystal display device having a plurality of picture elements arranged in a matrix including a plurality of rows and a plurality of columns. The liquid crystal display device includes a first substrate, a liquid crystal layer, and a second substrate. The first substrate, the liquid crystal layer, and the second substrate are arranged in this order from a back side toward a viewing screen side. The first substrate includes a first electrode, an insulating layer, and a second electrode in which elongated openings extending along a row direction or a column direction of the plurality of picture elements are provided separately for each of the picture elements. The first electrode, the insulating layer, and the second electrode are arranged in this order from the back side toward the viewing screen side. The first substrate further includes a plurality of non-linear elements placed separately in correspondence with each of the picture elements. The liquid crystal layer contains liquid crystal molecules and a chiral dopant. In a plan view, an alignment direction of the liquid crystal molecules beside the first substrate in absence of application of a voltage is placed parallel or orthogonal to a longitudinal direction of the openings.

### BRIEF DESCRIPTION OF THE DRAWINGS

FIG. 1 is a plan schematic view of a liquid crystal display device according to Embodiment 1;

FIG. 2 is an enlarged plan schematic view of the liquid crystal display device according to Embodiment 1;

FIG. 3 is an enlarged schematic view of an area surrounded by a dashed frame in FIG. 2;

FIG. 4 is a cross-sectional view taken along line IV-IV in FIG. 3;

FIG. 5 is an enlarged plan schematic view of a liquid crystal display device according to Embodiment 2;

FIG. 6 is an enlarged plan schematic view of a liquid crystal display device according to Embodiment 3;

FIG. 7 is an enlarged plan schematic view of a liquid crystal display device according to Embodiment 4; and

FIG. 8 is an enlarged plan schematic view of an FFS mode liquid crystal display device of a comparative embodiment.

### DESCRIPTION OF THE EMBODIMENTS

### Definitions of Terms

The term “viewing screen side” herein means a side of a liquid crystal panel or a display device that is closer to a screen (display surface), and the term “back side” herein means a side of the liquid crystal panel or the display device that is farther away from the screen (display surface).

That two straight lines (including axes, directions, and azimuths) are parallel to each other means that they form an angle (absolute value) of 0 degree or larger and 1 degree or smaller, preferably 0 degree (completely parallel). Further, that two straight lines (including axes, directions, and azimuths) are orthogonal to each other herein means that they form an angle larger than 89 degrees and smaller than or equal to 90 degrees, preferably 90 degrees (completely orthogonal).

The term “presence of the application of a voltage” means a state where a voltage higher than or equal to a threshold is applied between a first electrode and a second electrode. The term “absence of the application of a voltage” means a state (including the absence of the application of a voltage) where a voltage lower than the threshold is applied between the first electrode and the second electrode.

The pretilt angle of liquid crystal molecules denotes the angle of inclination of the liquid crystal molecules with respect to a direction parallel to a principal surface of a substrate. An angle parallel to the principal surface of the substrate is 0 degree, and an angle normal to the principal surface of the substrate is 90 degrees.

The following describes liquid crystal display devices according to embodiments of the present disclosure. The present disclosure is not limited in content to the following description of the embodiments but can be appropriately designed and changed within such a range as to fulfill a configuration of the present disclosure. In the following description, identical components or components having similar functions are appropriately given identical reference signs that are adhered to throughout different drawings, and a repeated description of such components is appropriately omitted. Aspects of the present disclosure may be appropriately combined with one another without departing from the scope of the present disclosure.

### Embodiment 1

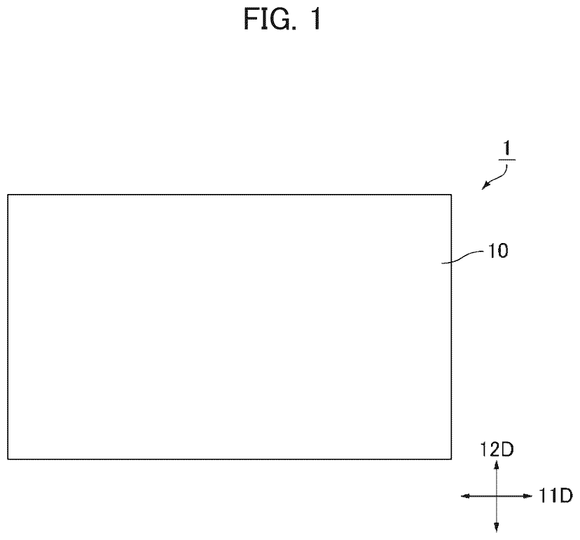

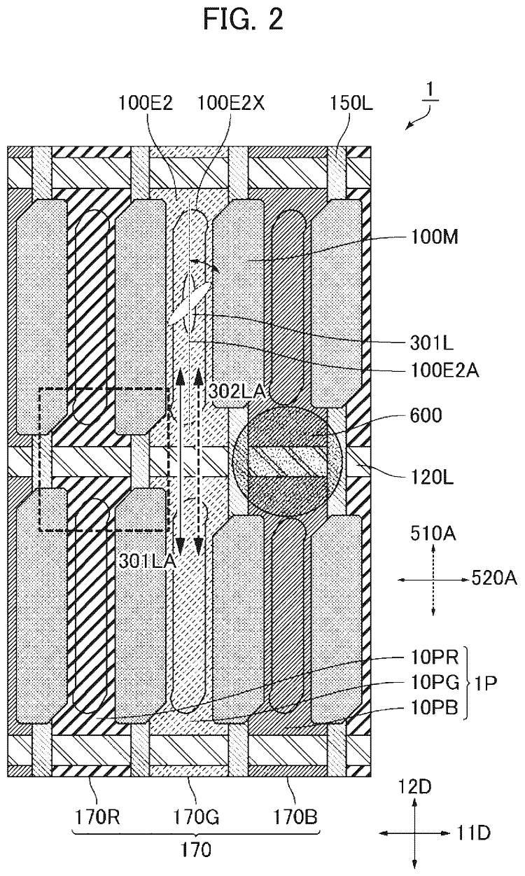

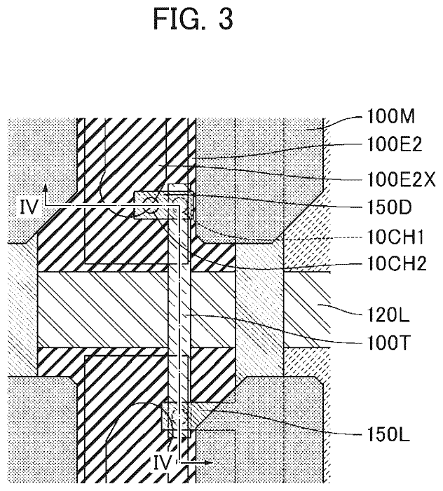

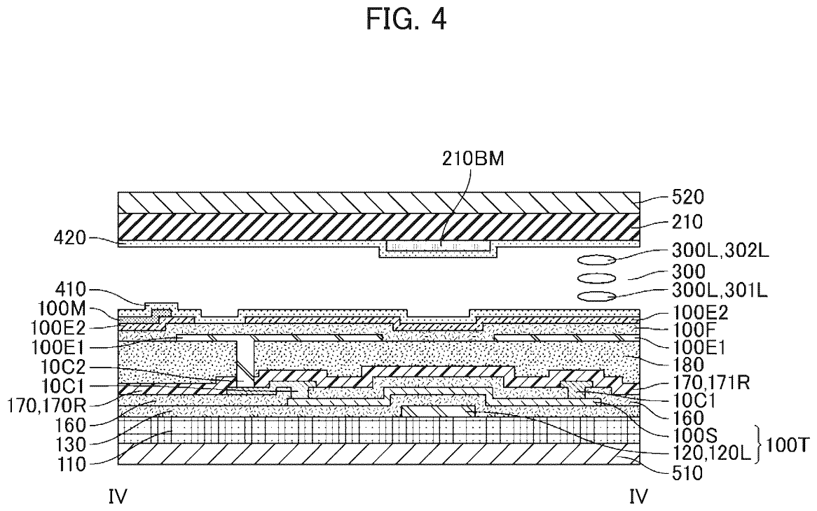

FIG. 1 is a plan schematic view of a liquid crystal display device according to Embodiment 1. FIG. 2 is an enlarged plan schematic view of the liquid crystal display device according to Embodiment 1. FIG. 3 is an enlarged schematic view of an area surrounded by a dashed frame (dashed quadrangular frame) in FIG. 2. FIG. 4 is a cross-sectional view (cross-sectional schematic view) taken along line IV-IV in FIG. 3.

As shown in FIGS. 1 to 4, the liquid crystal display device 1 of the present embodiment has a plurality of picture elements 10P arranged in a matrix including a plurality of rows and a plurality of columns. The liquid crystal display device 1 includes a first substrate 100, a liquid crystal layer 300, and a second substrate 200. The first substrate 100, the liquid crystal layer 300, and the second substrate 200 are arranged in this order from a back side toward a viewing screen side. The first substrate 100 includes a first electrode 100E1, an insulating layer 100F, and a second electrode 100E2 in which elongated openings 100E2X extending along a row direction or a column direction of the plurality of picture elements 10P are provided separately for each of the picture elements 10P. The first electrode 100E1, the insulating layer 100F, and the second electrode 100E2 are arranged in this order from the back side toward the viewing screen side. The first substrate 100 further includes a plurality of non-linear elements 100T placed separately in correspondence with each of the picture elements 10P. The liquid crystal layer 300 contains liquid crystal molecules 300L and a chiral dopant. In a plan view, an alignment direction of the liquid crystal molecules 300L beside the first substrate 100 in absence of application of a voltage is placed parallel or orthogonal to a longitudinal direction of the openings 100E2X.

The liquid crystal display device 1 of such an aspect is capable of performing a display by generating a transverse electric field (fringe field) in the liquid crystal layer 300 by applying a voltage between the first electrode 100E1 and the second electrode 100E2 and can achieve satisfactory image quality by sufficiently reducing the occurrence of leakage of light and mixture of colors in an oblique view. A mixture of colors in an oblique view is also referred to as a “color shift within a viewing angle”. For example, using the liquid crystal display device 1 of the present embodiment in a head-mounted display (HMD) gives image quality falling within a practical range. The liquid crystal display device 1 is an FFS (fringe field switching) mode liquid crystal display device.

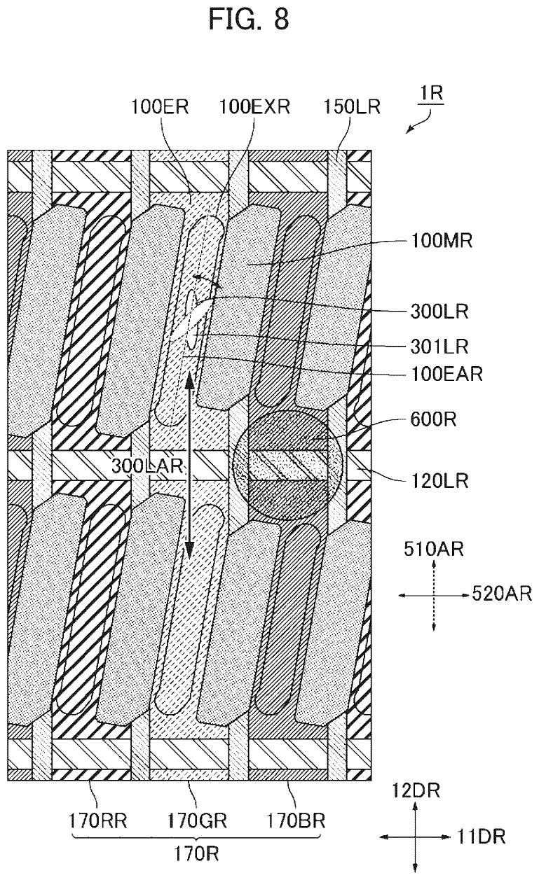

FIG. 8 is an enlarged plan schematic view of an FFS mode liquid crystal display device of a comparative embodiment.

As shown in FIG. 8, the liquid crystal display device 1R includes a first polarizing plate having a first polarizing axis 510AR, a first substrate, a liquid crystal layer containing liquid crystal molecules 300LR, a second substrate, and a second polarizing plate having a second polarizing axis 520AR. The first polarizing plate, the first substrate, the liquid crystal layer, the second substrate, and the second polarizing plate are arranged in this order from a back side toward a viewing screen side. The liquid crystal display device 1R further includes an elongated light-shielding film 100MR, a red color filter 170RR, a green color filter 170GR, a blue color filter 170BR, and a spacer 600R.

The first substrate of the liquid crystal display device 1R includes a gate line 120LR, a source line 150LR, and a pair of electrodes one of which is an electrode 100ER having elongated openings 100EXR provided therein. The openings 100EXR provided in the electrode 100ER are also called “slits” or “pixel slits”.

In consideration of the determination of the direction of movement of liquid crystal molecules, the placement of polarizers and optical films, or other purposes, the FFS mode liquid crystal display device 1R is configured such that in a plan view, an alignment direction 300LAR of liquid crystal molecules 300LR in the absence of the application of a voltage is parallel to a horizontal direction or a vertical direction of a screen of the liquid crystal display device 1R and forms an angle of approximately 5 degrees or larger and 15 degrees or smaller with respect to a longitudinal direction 100EAR of the pixel slits. That is, the longitudinal direction 100EAR of the pixel slits is placed at an angle of approximately 5 degrees or larger and 15 degrees or smaller with respect to the alignment direction 300LAR of liquid crystal molecules 300LR in the absence of the application of a voltage (in the example shown in FIG. 8, the vertical direction of the screen of the liquid crystal display device 1R). In recent years, it has been proposed that improvement in transmittance be brought about by also tilting, in conformance with the longitudinal direction of the pixel slits, the direction of extension of the source lines and the longitudinal direction of the light-shielding film with respect to the alignment direction of liquid crystal molecules in the absence of the application of a voltage.

However, leakage of light and mixture of colors and mixture of colors in an oblique view tend to undesirably occur depending on an angle formed by the alignment direction of the liquid crystal molecules and the longitudinal direction of the pixel slits. Further, when the alignment direction of the liquid crystal molecules and the longitudinal direction of the pixel slits are parallel to each other, the direction of movement of the liquid crystal molecules does not become stable, with the undesirable result that transmittance is unable to be sufficiently secured. As a result of further studies, the inventors found that when the longitudinal direction of the pixel slits, the direction of extension of the source lines, and the longitudinal direction of the light-shielding film are placed parallel to one another and at a tilt with respect to the alignment direction of the liquid crystal molecules, disturbances in the alignment direction of the liquid crystal molecules due to steps of the source lines and the light-shielding film and a light diffraction phenomenon caused by thin films (such as the light-shielding film and the source lines) forming a given angle with a polarization direction of a polarizing axis can be a factor of leakage of light. Further, the inventors also found that in a case where the alignment direction of the liquid crystal molecules and the longitudinal direction of the pixel slits are placed at the aforementioned angle to each other, it is difficult, in consideration of transmittance, to take measures to increase the width of the light-shielding film to sufficiently reduce mixture of colors in an oblique view.

On the other hand, the foregoing problems are addressed by the liquid crystal display device 1 of the present embodiment being configured such that as shown in FIG. 2, the longitudinal direction 100E2A of the openings 100E2X, as well as the alignment direction 301LA of the liquid crystal molecules 301L beside the first substrate 100 in the absence of the application of a voltage, is placed parallel to the horizontal direction or the vertical direction of the screen 10 of the liquid crystal display device 1 (i.e. the row direction or the column direction of the plurality of picture elements 10P) and that the liquid crystal layer 300 contains the liquid crystal molecules 300L and the chiral dopant. In the FFS mode, an electric field in an area where an electrode comes close to a substrate on which a pixel electrode and a common electrode is formed tends to affect the movement of the liquid crystal molecules. Therefore, the direction of movement of the liquid crystal molecules 301L is determined by the effect of the chiral dopant on the alignment direction 301LA of the liquid crystal molecules 301L beside the first substrate 100. For this reason, even if the alignment direction 301LA of the liquid crystal molecules 301L beside the first substrate 100 is placed parallel or orthogonal to the longitudinal direction 100E2A of the openings 100E2X, the direction of movement of the liquid crystal molecules 301L is unidirectionally controlled. This makes the liquid crystal display device 1 high in display quality. Further, in such a liquid crystal display device 1, for example, the source lines 150L and the light-shielding film 100M can be placed parallel to the horizontal direction or the vertical direction of the screen 10 of the liquid crystal display device 1 (and the polarization direction can also be placed parallel to the horizontal direction or the vertical direction of the screen 10 of the liquid crystal display device 1). The liquid crystal display device 1 can more sufficiently avoid leakage of light and mixture of colors in an oblique view while securing high transmittance.

The following describes the liquid crystal display device 1 of the present embodiment in detail.

As shown in FIGS. 1 to 4, the liquid crystal display device 1 of the present embodiment includes a first substrate 100, a liquid crystal layer 300, and a second substrate 200. The first substrate 100, the liquid crystal layer 300, and the second substrate 200 are arranged in this order from a back side toward a viewing screen side. The liquid crystal display device 1 includes an active area (image display area) where an image is displayed, and the active area is composed of a plurality of picture elements 10P arrayed in a matrix in a horizontal direction 11D of a screen 10 and a vertical direction 12D of the screen 10.

### First Substrate

The first substrate 100 includes a first support substrate 110, a plurality of gate lines 120L placed at a side of the first support substrate 110 that faces the liquid crystal layer 300, a first insulating layer 130 placed at a side of the plurality of gate lines 120L that faces the liquid crystal layer 300, and a plurality of source lines 150L placed at a side of the first insulating layer 130 that faces the liquid crystal layer 300. The plurality of gate lines 120L are placed parallel to the horizontal direction 11D of the screen 10. The plurality of source lines 150L are placed parallel to the vertical direction 12D of the screen 10. The plurality of gate lines 120L and the plurality of source lines 150L are formed in a grid pattern as a whole so as to demarcate each picture element 10P. A non-linear element 100T is placed at a point of intersection of each gate line 120L and each source line 150L.

The horizontal direction 11D forms an angle of 90 degrees with respect to the vertical direction 12D. The horizontal direction 11D corresponds to a row direction of picture elements 10P arranged in a matrix (hereinafter simply referred to as “row direction”), and the vertical direction 12D corresponds to a column direction of picture elements 10P arranged in a matrix (hereinafter simply referred to as “column direction”).

It is preferable that in a plan view, the gate line 120L be placed orthogonal to the longitudinal direction 100E2A of the openings 100E2X. That is, the first substrate 100 may include a gate line 120L, and in a plan view, the gate line 120L may be placed orthogonal to the longitudinal direction 100E2A of the openings 100E2X. In this case, one of a direction of extension of the gate line 120L and the longitudinal direction 100E2A of the openings 100E2X is placed parallel to the horizontal direction 11D of the screen 10, and the other can be placed parallel to the vertical direction 12D of the screen 10. Accordingly, the liquid crystal display device 1 makes it possible to better achieve improvement in transmittance and a reduction in mixture of colors in an oblique view while achieving an increase in resolution.

Although, in the present embodiment, the gate lines 120L are placed parallel to the horizontal direction 11D of the screen 10 and the source lines 150L are placed parallel to the vertical direction 12D of the screen 10, the gate lines 120L may be placed parallel to the vertical direction 12D of the screen 10 and the source lines 150L may be placed parallel to the horizontal direction 11D of the screen 10.

Each non-linear element 100T is a three-terminal switch (e.g. a thin-film transistor (TFT)) having a gate electrode, connected to a corresponding one of the plurality of gate lines 120L and a corresponding one of the plurality of source lines 150L, that protrudes from the corresponding gate line 120L (as part of the gate line 120L), a source electrode protruding from the corresponding source line 150L (as part of the source line 150L), a drain electrode 150D connected to a corresponding one of a plurality of pixel electrodes (in the present embodiment, first electrodes 100E1), and a semiconductor layer 100S. The source electrode and the drain electrode 150D are electrodes provided at the same source wiring layer 150 as the source line 150L, and the gate electrode is an electrode provided at the same gate wiring layer 120 as the gate line 120L. The semiconductor layer 100S is connected to the drain electrode 150D via a through-hole 10CH1. The first electrode 100E1 is connected to the drain electrode 150D via a through-hole 10CH2.

A gate driver is connected to the gate lines 120L. A source driver is connected to the source lines 150L. A controller is connected to the gate driver and the source driver. The gate driver supplies the gate lines 120L with scanning signals in sequence based on control exercised by the controller. At a timing when the non-linear elements 100T are brought by the scanning signals into the presence of the application of a voltage, the source driver supplies the source lines 150L with data signals based on control exercised by the controller.

Each of the pixel electrodes is set to a potential corresponding to a data signal supplied via a corresponding one of the non-linear elements 100T, and a fringe field is generated between the common electrode and the pixel electrode, so that the liquid crystal molecules 300L of the liquid crystal layer 300 rotate. By thus changing the retardation of the liquid crystal layer 300 by controlling the magnitude of a voltage that is applied between the common electrode and the pixel electrode, whether to transmit or not to transmit light is controlled.

The various types of wire and electrode that constitute the gate line 120L, the source line 150L, and the non-linear element 100T can be formed by forming a film of a metal such as copper, titanium, aluminum, molybdenum, or tungsten or an alloy thereof in a single layer or multiple layers by sputtering or other methods and then patterning the film by photolithography or other methods. Those of the various types of wire and electrode which are formed at the same layer are efficiently manufactured by using the same material.

The first substrate 100 includes the first support substrate 110, the gate wiring layer 120, at which the gate line 120L is provided, the first insulating layer 130, the semiconductor layer 100S, the source wiring layer 150, at which the source line 150L is provided, a second insulating layer 160, a color filter layer 170, a planarizing film 180, a first electrode 100E1, an insulating layer 100F, a second electrode 100E2 having an opening 100E2X provided therein, and a light-shielding film 100M in this order toward the liquid crystal layer 300.

The first insulating layer 130 is a gate insulating layer. The first insulating layer 130 is, for example, an inorganic insulating layer. Usable examples of the inorganic insulating layer include an inorganic film (relative dielectric constant ε=5 to 7) of, for example, silicon nitride (SiNₓ) or silicon oxide (SiO₂) and a laminated film thereof.

It is preferable that the semiconductor layer 100S contain an oxide semiconductor or p-Si (polycrystalline silicon). Possible examples of the oxide semiconductor include, but are not limited to, IGZO (registered trademark) (In—Ga—Zn—O: indium oxide-gallium-zinc) and ZnO (zinc oxide).

The second insulating layer 160 is, for example, an inorganic insulating film. Usable examples of the inorganic insulating film include an inorganic film (relative dielectric constant ε=5 to 7) of, for example, silicon nitride (SiNₓ) or silicon oxide (SiO₂) and a laminated film thereof.

The color filter layer 170 is placed at a side of the second insulating layer 160 that faces the liquid crystal layer 300. The color filter layer 170 is composed of red color filters 170R, blue color filters 170B, and green color filters 170G.

The plurality of picture elements 10P include red picture elements 10PR including the red color filters 170R, blue picture elements 10PB including the blue color filters 170B, and green picture elements 10PG including the green color filters 170G. One pixel 1P is constituted by three picture elements 10P, namely a red picture element 10PR, a blue picture element 10PB, and a green picture element 10PG. In one pixel 1P, these three picture elements 10P are arranged in stripes.

Although, in the present embodiment, the first substrate 100 includes the color filter layer 170, not the first substrate 100 but the second substrate 200 may include the color filter layer 170. The color filter layer 170 is, for example, a micro color filter layer.

The planarizing film 180 is placed at a side of the color filter layer 170 that faces the liquid crystal layer 300. The planarizing film 180 is an insulating film that absorbs asperities on a surface (foundation) on which the film is formed and that planarizes a substrate surface on which the film has been formed. The planarizing film 180 allows the liquid crystal display device 1 to remain the same in cell thickness. As the planarizing film 180, an organic insulating film is suitable. A usable example of the organic insulating film is an organic film of, for example, acrylic resin, polyimide resin, or novolak resin. A suitably usable example of the organic insulating film is an organic film of, for example, photosensitive acrylic resin with a low relative dielectric constant (relative dielectric constant ε=2 to 5).

The first electrode 100E1 at least partially faces the second electrode 100E2 across the insulating layer 100F. The second electrode 100E2 has provided therein openings 100E2X extending along the row direction or the column direction of the plurality of picture elements 10P. This allows the liquid crystal display device 1 to achieve the FFS mode as a display mode. That the first electrode 100E1 and the second electrode 100E2 partially face each other here means that at least part of the first electrode 100E1 faces at least part of the second electrode 100E2. In the second electrode 100E2, the elongated opening 100E2X are provided separately (only one by one) for each of the picture elements 10P.

One of the first electrode 100E1 and the second electrode 100E2 is a pixel electrode, and the other is a common electrode. In the present embodiment, the first electrode 100E1 is a pixel electrode, and the second electrode 100E2 is a common electrode.

The pixel electrode is an electrode placed in each area surrounded by two gate lines 120L that are adjacent to each other and two source lines 150L that are adjacent to each other. The pixel electrode is placed in each picture element 10P. The pixel electrode is connected to the corresponding non-linear element 100T and is connected to the corresponding source line 150L via the semiconductor layer 100S of the non-linear element 100T. The pixel electrode is set to a potential corresponding to a data signal that is supplied via the corresponding non-linear element 100T.

The common electrode is an electrode formed substantially all over the picture elements 10P regardless of the boundaries between the picture elements 10P. The common electrode is supplied with a common signal kept at a certain value, so that the common electrode is kept at a certain potential.

The second electrode 100E2 is placed closer to the liquid crystal layer 300 than is the first electrode 100E1. The opening 100E2X of the (upper-layer) second electrode 100E2 placed closer to the liquid crystal layer 300 is placed over the lower-layer first electrode 100E1. Although, in the present embodiment, the lower-layer first electrode 100E1 is placed in an area corresponding to at least the opening 100E2X, there may be an area where the first electrode 100E1 is not present in the area corresponding to the opening 100E2X. For example, in a case where the lower-layer first electrode 100E1 is a common electrode, the first electrode 100E1 may be a solid electrode having an opening provided in an area corresponding to a through-hole connecting the upper-layer second electrode 100E2, which is a pixel electrode, with the drain electrode of the non-linear element 100T.

Since an electric field that is applied to liquid crystal molecules 300L is determined by a potential difference between the opening 100E2X of the upper-layer second electrode 100E2 and the lower-layer first electrode 100E1, either the upper-layer electrode (second electrode 100E2) or the lower-layer electrode (first electrode 100E1) may be a pixel electrode or a common electrode in terms of how the liquid crystal molecules move. In a case where the upper-layer electrode is a pixel electrode, the upper-layer electrode has a configuration in which one opening 100E2X is provided in each quadrangular pixel electrode, as the pixel electrode needs to be electrically insulated from an adjacent pixel electrode. Meanwhile, in a case where the upper-layer electrode is a common electrode, the upper-layer electrode has a configuration in which one opening 100E2X (i.e. as many openings as picture elements in the common electrode as a whole) is provided in an area corresponding to each picture element of a solid electrode spread over the entire area of the screen.

It is preferable that the first electrode 100E1 be a pixel electrode and that the second electrode 100E2 be a common electrode. Such a liquid crystal display device 1 makes it possible to make a step attributed to an electrode smaller and, in addition, makes it possible to easily form a through-hole 10CH2 between the pixel electrode and the drain electrode. Specifically, this makes it hard for there to occur positional interference of the through-hole 10CH2 and the light-shielding film 100M, making it easy to design the liquid crystal display device 1. Further, in a case where the light-shielding film 100M is a conductor such as a metal, it becomes hard there to occur electrical interference of the through-hole 10CH2 and the light-shielding film 100M, making it easy to design the liquid crystal display device 1.

The first electrode 100E1 may be a common electrode, and the second electrode 100E2 may be a pixel electrode. Such a liquid crystal display device 1 makes it possible to decrease a parasitic capacitance [Cgd} of the non-linear element 100T.

The first electrode 100E1 and the second electrode 100E2 can be formed, for example, by forming a film of a transparent conductive material such as indium tin oxide (ITO), indium zinc oxide (IZO), zinc oxide (ZnO), or tin oxide (SnO) or an alloy thereof in a single layer or multiple layers by sputtering or other methods and then patterning the film by photolithography or other methods.

The insulating layer 100F is an interlayer insulating film and has a function of insulating the first electrode 100E1 and the second electrode 100E2 from each other. As the insulating layer 100F, an inorganic insulating film can be used. Usable examples of the inorganic insulating film include an inorganic film (relative dielectric constant ε=5 to 7) of, for example, silicon nitride (SiNₓ) or silicon oxide (SiO₂) and a laminated film thereof.

It is preferable that the first substrate 100 include a light-shielding film 100M. The light-shielding film 100M has a function of blocking light. The light-shielding film 100M needs only have an optical absorptance of 30% or higher. It is preferable that the sum of the optical absorptance and reflectance of the light-shielding film 100M be higher than or equal to 808, more preferably higher than or equal to 958. The optical absorptance of the light-shielding film 100M is obtained by performing a common reflectance measurement and a common transmittance measurement and subtracting the reflectance and the transmittance from 100%.

It is preferable that the light-shielding film 100M contain a metal. It is preferable that the metal contained in the light-shielding film 100M be a metal, such as molybdenum or titanium, whose reflectance is comparatively low. The light-shielding film 100M may contain a non-metal substance.

The light-shielding film 100M is, for example, a metal film. The metal film has a reflectance of, for example, 40% or higher and 60% or lower. The reflectance can is a reflectance in a visible light region (e.g. wavelengths of 380 nm to 780 nm) and can be measured by a method based on JIS R3106:2019. As a measurement device, a spectrophotometer (e.g. CM-700d manufactured by Konica Minolta, Inc.) can be used.

The light-shielding film 100M may be a layered product including a metal film and an insulating film. The insulating film included in the layered production is, for example, an inorganic insulating film. The layered product may be a layered product in which an insulating film of, for example, silicon oxide or silicon nitride is sandwiched between a plurality of metal films. In a case where the light-shielding film 100M is such a layered product, it is preferable that the metal films included in the layered product be semi-transmissive metal thin-film layers. Such an aspect makes it possible to reduce the reflectance of the light-shielding film 100M by utilizing interference of light.

It is preferable that the light-shielding film 100M be placed between the plurality of picture elements 10P (at boundaries of the picture elements 10P) and that a shape of the light-shielding film 100M be an elongated shape. That is, the first substrate 100 may include an elongated light-shielding film 100M placed between the plurality of picture elements 10P (at boundaries of the picture elements 10P), and in a plan view, a longitudinal direction of the light-shielding film 100M may be placed parallel to the longitudinal direction 100E2A of the openings 100E2X. In the liquid crystal display device 1 of such an aspect, the longitudinal direction of the light-shielding film 100M and the longitudinal direction 100E2A of the openings 100E2X can be placed parallel to the horizontal direction 11D or the vertical direction 12D of the screen 10 of the liquid crystal display device 1. This makes it possible to achieve improvement in transmittance and a reduction in mixture of colors in an oblique view while achieving an increase in resolution.

It is preferable that between the plurality of picture elements 10P (at boundaries of the picture elements 10P), at least part of the elongated light-shielding film 100M be placed in an island shape to overlap the source lines 150L. This allows the liquid crystal display device 1 to more sufficiently suppress a color deviation during monochromatic display due to leakage of light from an adjacent picture element 10P primarily at an oblique viewing angle.

### Second Substrate

The second substrate 200 includes a second support substrate 210.

The second substrate 200 may also have a second substrate side light-shielding film 20BM at a side of the second support substrate 210 that faces the liquid crystal layer 300. The second substrate side light-shielding film 20BM may be provided in a grid pattern so as to demarcate each color filter.

The second substrate side light-shielding film 20BM is, for example, a black matrix layer. The black matrix layer is made of any material that has a light blocking effect; however, as the material, a resin material containing a black pigment or a metal material having a light blocking effect is suitably used. The black matrix layer is formed, for example, by applying photosensitive resin containing a black pigment to form a film and subjecting the film to photolithography, which includes performing exposure, development, or other processes.

It is preferable that the second substrate side light-shielding film 20BM be extended along the row direction (in the present embodiment, the horizontal direction 11D) between two picture elements 10P that are adjacent to each other in the column direction (in the present embodiment, the vertical direction 12D) and not be placed between two picture elements 10P that are adjacent to each other in the row direction (not be extended along the column direction between two picture elements 10P that are adjacent to each other in the row direction). The liquid crystal display device 1 of such an aspect makes it possible to better suppress delamination of the second substrate side light-shielding film 20BM than in a case where the second substrate side light-shielding film 20BM is extended both between two picture elements 10P that are adjacent to each other in the column direction and two picture elements 10P that are adjacent to each other in the row direction. Such a liquid crystal display device 1 also makes it possible to, from the point of view of the positioning accuracy with which the first substrate 100 and the second substrate 200 are bonded together, make the aperture ratio higher than in a case where the second substrate side light-shielding film 20BM is extended in the column direction. The second substrate side light-shielding film 20BM is extended, for example, on the outer frame of the screen 10 of the liquid crystal display device 1 and in the row direction between each picture element 10P and the other. Being extended along a certain direction herein means being extended parallel to a certain direction.

### Spacer

A spacer 600 may be provided between the first substrate 100 and the second substrate 200. The spacer 600 has a function of securing a gap of space in which the liquid crystal layer 300 is formed. The spacer 600 may be placed on at least either the first substrate 100 or the second substrate 200 or may be placed on both of the substrates. A spacer 600 provide in the second substrate 200 does not need to have its tip in contact with the first substrate 100.

The spacer 600 is in the shape of, for example, a column. The spacer 600 may, for example, be polygonal, circular, or elliptical in planar shape. The spacer 600 is, for example, in the shape of a truncated cone, a circular cylinder, a truncated elliptical cone, a truncated pyramid, a prism, or other shapes. Examples of the truncated pyramid include a truncated quadrangular pyramid. Examples of the prism include a quadrangular prism.

It is preferable that the spacer 600 contain, for example, a hardened material of photosensitive resin. Examples of the photosensitive resin include resin having an ultraviolet reactive functional group.

### Liquid Crystal Layer

The liquid crystal layer 300 contains the liquid crystal molecules 300L and the chiral dopant. More specifically, the liquid crystal layer 300 is composed of a liquid crystal material containing the liquid crystal molecules 300L and the chiral dopant and is configured such that the amount of light that travels through the liquid crystal layer 300 is controlled by applying a voltage to the liquid crystal layer 300 and changing a state of alignment of the liquid crystal molecules 300L in the liquid crystal material according to the voltage thus applied. The liquid crystal material exhibits nematic liquid crystallinity within a given temperature range.

In the present embodiment, the liquid crystal molecules 300L have positive dielectric constant anisotropy. The liquid crystal display device 1 of such an aspect can bring about improvement in response speed.

The dielectric constant anisotropy (As) is defined by Formula (L1) as follows:

Δε=(Dielectric constant of liquid crystal molecules in long axis direction)−(Dielectric constant of liquid crystal molecules in short axis direction) Formula (L1)

Liquid crystal molecules whose dielectric constant anisotropy assumes a positive value are called “positive liquid crystals”, and liquid crystal molecules whose dielectric constant anisotropy assumes a negative value are called “negative liquid crystals”. A long axis direction of the liquid crystal molecules 300L is an alignment direction (slow axis direction). In the absence of the application of a voltage, the liquid crystal molecules 300L are homogeneously aligned.

Although the chiral dopant is not limited to particular dopants, suitably usable examples of the dopant include chiral dopants that cause the liquid crystal molecules 300L to be twisted clockwise toward the front when the liquid crystal layer 300 is seen in a plan view from the viewing screen side. Specific examples include S-811 (manufactured by Merck Electronics, Inc.). The liquid crystal layer 300 may contain one type of chiral dopant or may contain two or more types of chiral dopant.

In the liquid crystal layer 300, the liquid crystal molecules 300L are in twist alignment. It is preferable that the content of a chiral dopant contained in the liquid crystal layer 300 (or the total amount of two types of chiral dopant contained in the liquid crystal layer 300) be adjusted to satisfy a relational expression “(0.05×p)<d<(0.25×p)”, where d is the thickness of the liquid crystal layer 300 and p is a twist pitch between the liquid crystal molecules 300L brought into twist alignment by the chiral dopant. In other words, it is preferable that the thickness (d) of the liquid crystal layer 300 be greater than or equal to 5% and less than 25% of the twist pitch (p) between the liquid crystal molecules 300L brought into twist alignment by the chiral dopant. This allows the liquid crystal display device 1 to become higher in response speed in the presence of the application of a voltage in addition to becoming more sufficiently less prone to display defects. In general, even with the content of a chiral dopant contained in the liquid crystal layer 300 being the same, the twist pitch (p) tends to become shorter with a decrease in ambient temperature. Therefore, it is preferable to satisfy the aforementioned relation at the lowest temperature within the operating temperature range of the liquid crystal display device 1.

It is preferable that the thickness (also referred to as “cell thickness) (d) of the liquid crystal layer 300 be greater than or equal to 10%, more preferably greater than or equal to 15%, of the aforementioned twist pitch (p). The twist pitch is a thickness of the liquid crystal layer 300 that corresponds to a single winding (twist of 360 degrees) of a helical structure.

The liquid crystal display device 1 of the present embodiment, in which the liquid crystal molecules 300L have positive dielectric constant anisotropy, is configured such that in a plan view, the alignment direction 301LA of the liquid crystal molecules 301L beside the first substrate 100 in the absence of the application of a voltage is placed parallel to the longitudinal direction 100E2A of the openings 100E2X and that the liquid crystal layer 300 contains a chiral dopant in the aforementioned aspect. As mentioned above, the liquid crystal display device 1 of such an aspect is high in display quality and also sufficiently high in response speed and also makes it possible to more sufficiently reduce leakage of light and mixture of colors in an oblique view while securing high transmittance.

In a plan view, an alignment direction 302LA of the liquid crystal molecules 302L beside the second substrate 200 in the absence of the application of a voltage may be parallel to the alignment direction 301LA of the liquid crystal molecules 301L beside the first substrate 100 in the absence of the application of a voltage. That is, it is preferable that the alignment direction 302LA of the liquid crystal molecules 302L be placed parallel to the longitudinal direction 100E2A of the openings 100E2X. This allows the liquid crystal display device 1 to achieve higher contrast and further increase the response speed.

Unless otherwise noted, the alignment direction of liquid crystal molecules is the alignment direction of liquid crystal molecules located in a central part of an opening of the second electrode in a plan view. The central part of the opening is an area of overlap between a central part (i.e. an area extending over a certain range) of the opening in the longitudinal direction and a central part (i.e. an area extending over a certain range) of the opening in a width direction (i.e. a direction forming an angle of 90 degrees with respect to the longitudinal direction). The central part of the opening in the longitudinal direction is, for example, an area located in the middle one of three areas obtained by dividing the opening into three equal parts in the longitudinal direction. The central part of the opening in the width direction is, for example, an area located in the middle one of three areas obtained by dividing the opening into three equal parts in the width direction.

The alignment direction of liquid crystal molecules in the absence of the application of a voltage can be specified in the following manner.

Since an alignment film (e.g. a commonly used heat-resistant polymer alignment film) has a phase difference in the alignment direction of liquid crystal molecules, the alignment direction of liquid crystal molecules in the absence of the application of a voltage can be the direction of the phase difference of the alignment film as measured by a micropolarization measurement device. That is, the direction of the phase difference of the first alignment film 410 can be made the alignment direction 301LA of the liquid crystal molecules 301L beside the first substrate 100 in the absence of the application of a voltage. Similarly, the direction of the phase difference of the second alignment film 420 can be made the alignment direction 302LA of the liquid crystal molecules 302L beside the second substrate 200 in the absence of the application of a voltage. As the micropolarization measurement device, for example, a “TFM-120AFT-PC” manufactured by ORC MANUFACTURING CO., LTD. is used.

In a case where the phase difference of the alignment film is so minute that it is difficult to specify the direction of the phase difference of the alignment film, the alignment direction of liquid crystal molecules in the absence of the application of a voltage may be a direction of minimum transmittance of polarized light that falls on a layered product including the alignment film, a liquid crystal layer containing liquid crystal molecules, and a polarizing plate in this order and that has a polarizing axis forming an angle of 90 degrees with respect to a transmission axis of the polarizing plate from the direction of the alignment film.

In the present embodiment, it is preferable that a pretilt angle of the liquid crystal molecules 301L beside the first substrate 100 in the absence of the application of a voltage be substantially 0 degree with respect to a principal surface of the first substrate 100 and that a pretilt angle of the liquid crystal molecules 302L beside the second substrate 200 in the absence of the application of a voltage be substantially 0 degree with respect to a principal surface of the second substrate 200. This allows the liquid crystal display device 1 to further achieve high contrast and high transmittance. Being substantially 0 degrees with respect to a principal surface of a substrate herein means larger than or equal to 0 degree and smaller than 1 degree, preferably larger than or equal to 0 degree and smaller than or equal to 0.5 degree, more preferably larger than or equal to 0 degree and smaller than or equal to 0.2 degree, with respect to the principal surface of the substrate.

### Alignment Films

It is preferable that the liquid crystal display device 1 further include alignment films. More specifically, it is preferable that the liquid crystal display device 1 include a first alignment film 410 between the first substrate 100 and the liquid crystal layer 300 and a second alignment film 420 between the second substrate 200 and the liquid crystal layer 300 (see FIGS. 1 to 4). The first alignment film 410 and the second alignment film 420 have a function of controlling the alignment of the liquid crystal molecules 300L contained in the liquid crystal layer 300.

It is preferable that the first alignment film 410 and the second alignment film 420 be horizontal alignment films. This makes it easy to control the pretilt angle of the liquid crystal molecules 300L within the aforementioned range. The horizontal alignment films have a function of aligning liquid crystal molecules in the absence of the application of a voltage.

Examples of alignment process methods for the first alignment film 410 and the second alignment film 420 include a method (degradative photo-alignment method) in which a macromolecular chain of an alignment film in a certain direction is cut by irradiation with polarized ultraviolet rays, a method (anisotropic photo-alignment method) in which a photosensitive group in an alignment film is brought into a cis-trans isomerization reaction by irradiation with polarized ultraviolet rays, and a method (rubbing alignment method) in which a macromolecular chain on a surface of an alignment film is aligned in a certain direction by rubbing the surface with raised fabric. The alignment process methods for the first alignment film 410 and the second alignment film 420 may be the same as or different from each other.

### Polarizing Plates

It is preferable that the liquid crystal display device further include polarizing plates. More specifically, the liquid crystal display device 1 may further include a first polarizing plate 510 having a first polarizing axis 510A and a second polarizing plate 520 having a second polarizing axis 520A (see FIGS. 1 to 4). The first polarizing plate 510 may be placed at a back side of the first substrate 100, and the second polarizing plate 520 may be placed at a viewing screen side of the second substrate 200.

The first polarizing plate 510 and the second polarizing plate 520 may be placed such that the first polarizing axis 510A and the first polarizing axis 510A are orthogonal to each other. The term “polarizing axis” here means a transmission axis. The first polarizing plate 510 and the second polarizing plate 520 are, for example, absorptive polarizing plates. The first polarizing plate 510 have the first polarizing axis 510A and a first absorption axis orthogonal to the first polarizing axis 510A, and the second polarizing plate 520 have the second polarizing axis 520A and a second absorption axis orthogonal to the second polarizing axis 520A. The liquid crystal display device 1 of such an aspect can further reduce leakage of light and achieve further satisfactory image quality.

In a plan view, the second polarizing axis 520A may be placed parallel or orthogonal to the longitudinal direction 100E2A of the openings 100E2X, i.e. the alignment direction 302LA of the liquid crystal molecules 302L beside the second substrate 200 in the absence of the application of a voltage. The liquid crystal display device 1 of such an aspect makes it easy to design an outgoing light side optical system, can reduce leakage of light, and can bring about improvement in contrast of the liquid crystal display device 1.

For example, in a plan view, the first polarizing axis 510A may be placed parallel to the longitudinal direction 100E2A of the openings 100E2X (i.e. the alignment direction 301LA of the liquid crystal molecules 301L beside the first substrate 100 in the absence of the application of a voltage), and the second polarizing axis 520A may be placed orthogonal to the longitudinal direction 100E2A of the openings 100E2X (i.e. the alignment direction 302LA of the liquid crystal molecules 302L beside the second substrate 200 in the absence of the application of a voltage). Alternatively, in a plan view, the first polarizing axis 510A may be placed orthogonal to the longitudinal direction 100E2A of the openings 100E2X, and the second polarizing axis 520A may be placed parallel to the longitudinal direction 100E2A of the openings 100E2X.

### Other Components

It is preferable that the liquid crystal display device 1 further include a light source. The light source is not limited to particular light sources as long as it emits light, and may be of any type such as a direct type or an edge type. It is preferable that the light source include, for example, a light source such as a light-emitting diode (LED), a light guide plate, and a reflection sheet, and the light source may further include a diffusion sheet and a prism sheet. For example, the liquid crystal display device 1 shown in FIG. 4 includes a backlight (not illustrated) at the back of the first polarizing plate 510.

In addition to the aforementioned components, the liquid crystal display device 1 is also constituted by a plurality of members such as an external circuit such as a TCP (tape carrier package) or a PCB (printed circuit board), an optical film such as a viewing angle expansion film and a brightness enhancement film, and a bezel (frame), and some members may be incorporated into others. A description of these components used is omitted, as they are not limited to particular components and are normally used in the field of liquid crystal display devices.

### Embodiment 2

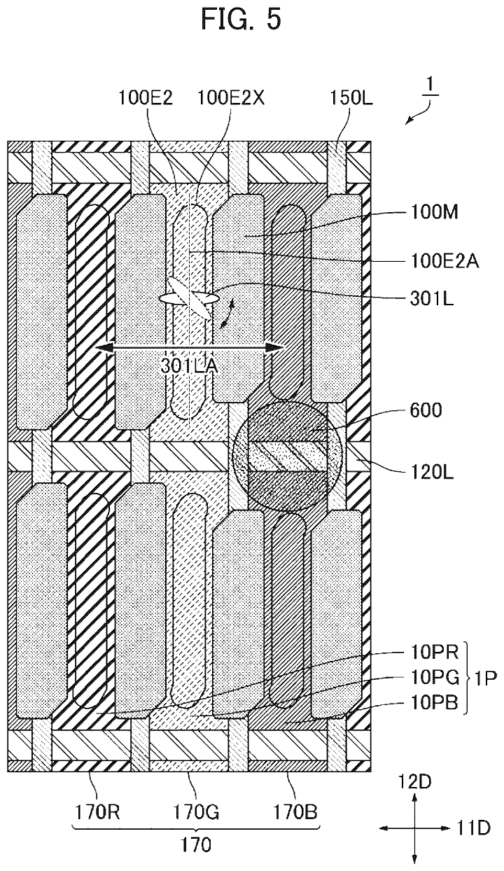

The present embodiment primarily describes features peculiar to the present embodiment and omits a description of contents that overlap those of Embodiment 1 described above. FIG. 5 is an enlarged plan schematic view of a liquid crystal display device according to Embodiment 2. The liquid crystal display device 1 of the present embodiment is substantially the same as the liquid crystal display device 1 of Embodiment 1 except that the dielectric constant anisotropy of the liquid crystal molecules 300L and the alignment direction of the liquid crystal molecule 300L in the absence of the application of a voltage are different.

While the liquid crystal molecules 300L of the liquid crystal display device 1 of Embodiment 1 described above have positive dielectric constant anisotropy, the liquid crystal molecules 300L have negative dielectric constant anisotropy in the present embodiment. The liquid crystal display device 1 of such an aspect can bring about improvement in transmittance.

The liquid crystal display device 1 of the present embodiment, in which the liquid crystal molecules 300L have negative dielectric constant anisotropy, is configured such that in a plan view, the alignment direction 301LA of the liquid crystal molecules 301L beside the first substrate 100 in the absence of the application of a voltage is placed orthogonal to the longitudinal direction 100E2A of the openings 100E2X and that the liquid crystal layer 300 contains a chiral dopant in the aforementioned aspect. As mentioned above, the liquid crystal display device 1 of such an aspect is high in display quality and also sufficiently high in transmittance and also makes it possible to more sufficiently reduce leakage of light and mixture of colors in an oblique view while securing high transmittance.

Further, in a plan view, the alignment direction 302LA of the liquid crystal molecules 302L beside the second substrate 200 in the absence of the application of a voltage may be parallel to the alignment direction 301LA of the liquid crystal molecules 301L beside the first substrate 100 in the absence of the application of a voltage. That is, it is also preferable that the alignment direction 302LA of the liquid crystal molecules 302L be placed equal to the longitudinal direction 100E2A of the openings 100E2X. This allows the liquid crystal display device 1 to achieve high contrast and increase the response speed.

### Embodiment 3

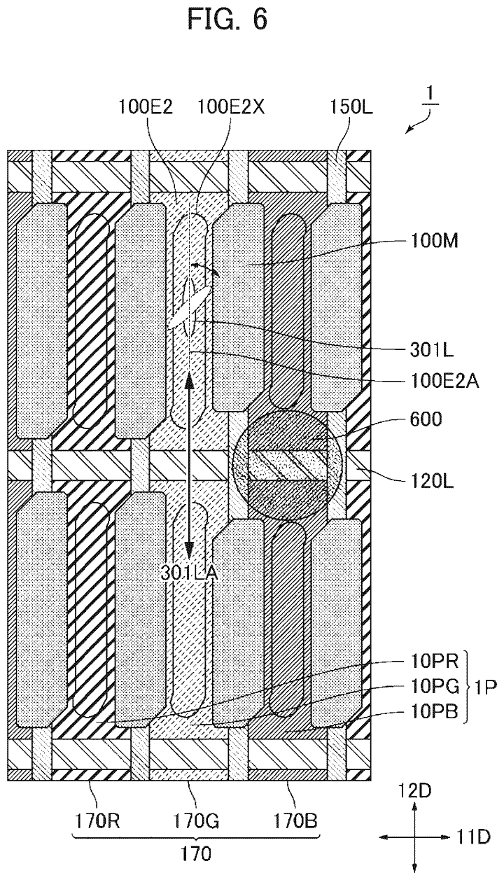

The present embodiment primarily describes features peculiar to the present embodiment and omits a description of contents that overlap those of Embodiment 1 described above. FIG. 6 is an enlarged plan schematic view of a liquid crystal display device according to Embodiment 3. The liquid crystal display device 1 of the present embodiment has substantially the same configuration as that of the liquid crystal display device 1 of Embodiment 1 except that the pretilt angle of the liquid crystal molecules 301L beside the first substrate 100 in the absence of the application of a voltage is larger than or equal to 1 degree with respect to the principal surface of the first substrate 100. The pretilt angle of the liquid crystal molecules 302L beside the second substrate 200 in the absence of the application of a voltage may be substantially 0 degree with respect to the principal surface of the second substrate 200.

It is preferable that the pretilt angle of the liquid crystal molecules 301L beside the first substrate 100 in the absence of the application of a voltage be larger than or equal to 1 degree and smaller than or equal to 5 degrees. In the liquid crystal display device 1 of such an aspect, the chiral dopant causes the liquid crystal molecules 300L beside the first substrate 100 and beside the second substrate 200 to be more highly asymmetric. This makes it easy for the liquid crystal molecules 301L beside the first substrate 100 to move. This brings about further improvement in alignment stability of the liquid crystal molecules 300L in the presence of the application of a voltage, thus making it possible to further improve the response speed of the liquid crystal display device 1. In other words, when the pretilt angle of the liquid crystal molecules 301L falls within the aforementioned range, the liquid crystal display device 1 can exhibit more satisfactory display characteristics, as the liquid crystal molecule 300L can keep a more stable state of alignment. It is preferable that the aforementioned pretilt angle be larger than or equal to 1 degree and smaller than or equal to 4 degrees, more preferably larger than or equal to 1 degree and smaller than or equal to 3 degrees, even more preferably larger than or equal to 2 degrees and smaller than or equal to 3 degrees.

Also in the present embodiment, it is preferable that the first alignment film 410 and the second alignment film 420 be horizontal alignment films. An example of a method for easily adjusting the pretilt angle of the liquid crystal molecules 301L beside the first substrate 100 within the aforementioned range is a method for performing an alignment process on the first alignment film 140 by a rubbing method using a rubbing alignment film (e.g. an liquid crystal alignment material (SUNEVER) “SE” Series manufactured by Nissan Chemical Corporation). The direction of the rubbing process may be, for example, a direction from top to bottom of FIG. 6 or a direction from bottom to top of FIG. 6. Performing the rubbing process in the former direction causes a downward pretilt angle to be formed, and performing the rubbing process in the latter direction causes an upward pretilt angle to be formed. Substantially the same effects are brought about no matter in which direction the rubbing process is performed.

### Embodiment 4

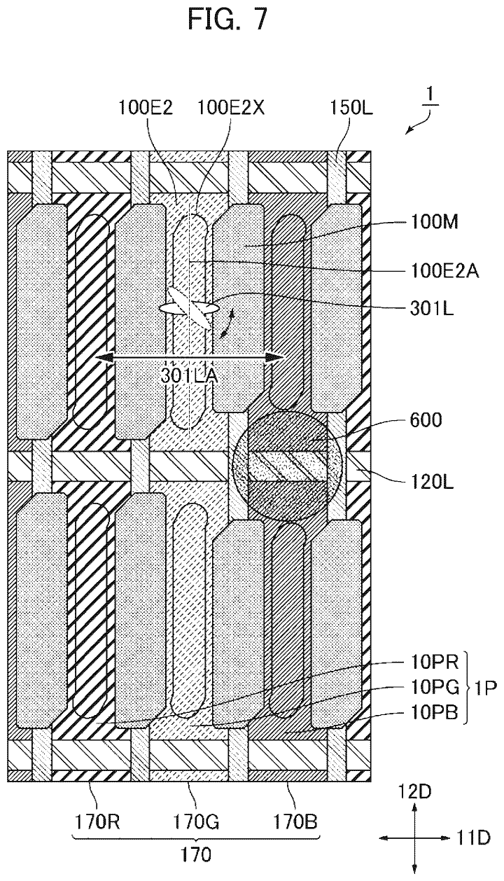

The present embodiment primarily describes features peculiar to the present embodiment and omits a description of contents that overlap those of Embodiment 2 described above. FIG. 7 is an enlarged plan schematic view of a liquid crystal display device according to Embodiment 4. The liquid crystal display device 1 of the present embodiment has substantially the same configuration as that of the liquid crystal display device 1 of Embodiment 1 except that the pretilt angle of the liquid crystal molecules 301L beside the first substrate 100 in the absence of the application of a voltage is larger than or equal to 1 degree with respect to the principal surface of the first substrate 100. The pretilt angle of the liquid crystal molecules 302L beside the second substrate 200 in the absence of the application of a voltage may be substantially 0 degree with respect to the principal surface of the second substrate 200.

It is preferable that the pretilt angle of the liquid crystal molecules 301L beside the first substrate 100 in the absence of the application of a voltage be larger than or equal to 1 degree and smaller than or equal to 5 degrees. In the liquid crystal display device 1 of such an aspect, the chiral dopant causes the liquid crystal molecules 300L beside the first substrate 100 and beside the second substrate 200 to be more highly asymmetric. This makes it easy for the liquid crystal molecules 301L beside the first substrate 100 to move. This brings about further improvement in alignment stability of the liquid crystal molecules 300L in the presence of the application of a voltage, thus making it possible to further improve the response speed of the liquid crystal display device 1. In other words, when the pretilt angle of the liquid crystal molecules 301L falls within the aforementioned range, the liquid crystal display device 1 can exhibit more satisfactory display characteristics, as the liquid crystal molecule 300L can keep a more stable state of alignment. It is preferable that the aforementioned pretilt angle be larger than or equal to 1 degree and smaller than or equal to 4 degrees, more preferably larger than or equal to 1 degree and smaller than or equal to 3 degrees, even more preferably larger than or equal to 2 degrees and smaller than or equal to 3 degrees.

Also in the present embodiment, it is preferable that the first alignment film 410 and the second alignment film 420 be horizontal alignment films. The method for easily adjusting the pretilt angle of the liquid crystal molecules 301L beside the first substrate 100 within the aforementioned range is hereby incorporated by reference to the description given in Embodiment 3 described above.

While the foregoing has describes embodiments of the present disclosure, all of the individual matters described can be applied to the present disclosure in general.

The following describes effects of the present disclosure with reference to examples; however, the present disclosure is not limited by these examples. The contrast was measured using a “Luminance Colorimeter BM-5A” (manufactured by Topcon Technohouse Corp.), and the transmittance and the response speed were measured using an “LCD-5200” (manufactured by Otsuka Electronics Co., Ltd.).

### Example 1-1

A liquid crystal display device 1 of Example 1-1 corresponding to the liquid crystal display device 1 of Embodiment 1 was fabricated (see FIGS. 1 to 4). The liquid crystal display device of the present example was an active matric liquid crystal display device for use in an HMD of 1400 ppi. Each pixel (each pixel 1P) had a size of 18 μm per side, and each subpixel (picture element 10P) had a size of 6 μm×18 μm.

The liquid crystal display device 1 includes a first polarizing plate 510, a first substrate 100, a first alignment film 410, a liquid crystal layer 300, a second alignment film 420, a second substrate 200, and a second polarizing plate 520 arranged in this order from a back side toward a viewing screen side.

The liquid crystal display device 1 of the present example includes a first substrate 100 fabricated in the following manner. First, a gate wiring layer 120 including gate electrodes and gate lines 120L, a gate insulating layer (first insulating layer 130), TFTs (non-linear elements 100T) having IGZO (registered trademark) as semiconductor layers 100S, and a source wiring layer 150 including source electrodes and source lines 150L were formed in sequence over a first support substrate 110. The gate lines 120L were extended parallel to a horizontal direction 11D of a screen 10, and the source lines 150L were extended parallel to a vertical direction 12D of the screen 10. The source lines 150L also function as a light-shielding film between the picture elements 10P. While IGZO (registered trademark) was used as the semiconductor layers 100S to drive the picture elements 10P, TFTs using p-Si as semiconductor layers were used in a peripheral circuit section of the liquid crystal display device 1.

Furthermore, on top of the source wiring layer 150, a color filter layer 170 composed of red color filters 170R, blue color filters 170B, and green color filters 170G was formed using colored organic resists. Next, a planarizing film 180 composed of an organic insulating film was formed on top of the color filter layer 170 to secure flatness. Next, through-holes 10CH2 for electrically connecting drain electrodes 150D of the TFTs and pixel electrodes were bored through the color filter layer 170 and the planarizing film 180.

Next, for performing a display in an FFS mode, the first electrodes 100E1, which served as pixel electrodes, an insulating layer 100F, and a second electrode 100E2 serving as a common electrode were formed in this order over the planarizing film 180. The first electrodes 100E1 and the second electrode 100E2 were transparent electrodes. Next, an elongated light-shielding film 100M was formed from molybdenum on top of the second electrode 100E2, whereby the first substrate 100 was fabricated.

Furthermore, a first alignment film 410 and a spacer 600 for securing cell thickness were formed in this order over the light-shielding film 100M. Although, in the present example, the spacer 600 was formed on the first substrate 100, the spacer 600 may be formed on a second substrate 200 or may be formed on both the first substrate 100 and the second substrate 200.

The second electrode 100E2 had provided therein elongated openings 100E2X extending along a row direction or a column direction of the plurality of picture elements 10P, and in a plan view, a longitudinal direction 100E2A of the openings 100E2X was placed parallel (specifically, at an angle of 0 degree) to the vertical direction 12D of the screen 10. Further, in a plan view, a longitudinal direction of the light-shielding film 100M was also placed parallel (specifically, at an angle of 0 degree) to the vertical direction 12D of the screen 10.

The first alignment film 410 used was a photodegradable alignment film that, when irradiated with polarized ultraviolet rays, causes liquid crystal molecules to align themselves in a direction perpendicular to transmitted polarized light. A photo-alignment process was performed by irradiating the first alignment film 410 with polarized ultraviolet rays so that in a plan view, an alignment direction 301LA of liquid crystal molecules 301L beside the first substrate 100 in the absence of the application of a voltage was placed parallel to the longitudinal direction 100E2A of the openings 100E2X and was also placed parallel to the vertical direction 12D of the screen 10.

Next, the second substrate 200 of the present example was fabricated by forming a second substrate side light-shielding film 20BM on a second support substrate 210. The second substrate side light-shielding film 20BM was placed on an outer frame of the screen 10 and was extended along the row direction (horizontal direction 11D) between two picture elements 10P that were adjacent to each other in the column direction (vertical direction 12D). The second substrate side light-shielding film 20BM was not placed between two picture elements 10P that were adjacent to each other in the row direction (i.e. was not placed along the column direction between two picture elements 10P that were adjacent to each other in the row direction).

Furthermore, a second alignment film 420 was formed on the second substrate side light-shielding film 20BM. An alignment process was performed on the second alignment film 420 so that in a plan view, an alignment direction 302LA of liquid crystal molecules 302L beside the second substrate 200 in the absence of the application of a voltage was placed parallel to the vertical direction 12D of the screen 10.

A liquid crystal cell was fabricated by placing the first substrate 100 thus fabricated with the first alignment film 410 and the second substrate 200 thus fabricated with the second alignment film 420 so that the first alignment film 410 and the second alignment film 420 faced each other and bonding the two substrates together with the liquid crystal layer 300 sandwiched therebetween. Next, the first polarizing plate 510 having the first polarizing axis 510A was placed at a side of the first substrate 100 that faced away from the liquid crystal layer 300, and the second polarizing plate 520 having the second polarizing axis 520A was placed at a side of the second substrate 200 that faced away from the liquid crystal layer 300 such that in a plan view, the first polarizing axis 510A and the second polarizing axis 520A were orthogonal to each other and that the second polarizing axis 520A was orthogonal to the longitudinal direction 100E2A of the openings 100E2X. The second polarizing axis 520A was placed parallel to the vertical direction 12D of the screen 10. Further, to the liquid crystal cell, a driver and a driving circuit system were connected. Furthermore, a backlight system was placed at the back of the first polarizing plate 510. Thus, the liquid crystal display device 1 of the present example was fabricated.

As the liquid crystal material that constitutes the liquid crystal layer 300, a liquid crystal material obtained by adding a chiral dopant into a liquid crystal mixture having positive dielectric constant anisotropy and exhibiting a nematic phase within a given temperature range. As the chiral dopant, “S-811” manufactured by Merck Electronics Inc. was used, and the twist pitch (p) between the liquid crystal molecules 300L brought into twist alignment was adjusted to be approximately eight times greater than the cell thickness d of the liquid crystal layer 300. That is, the thickness (d) of the liquid crystal layer 300 was 12.5% of the twist pitch (p).

In the present example, in a plan view, the alignment direction 301LA of liquid crystal molecules 301L beside the first substrate 100 in the absence of the application of a voltage was placed parallel (specifically, at an angle of 0 degree) to the longitudinal direction 100E2A of the openings 100E2X.

The liquid crystal display device 1 of the present example had reduced leakage of light and also had sufficiently reduced mixture of colors in an oblique view. Further, as a result of measurement of the contrast using a “Luminance Colorimeter BM-5A” (manufactured by Topcon Technohouse Corp.), it was found that the liquid crystal display device 1 of the present example had a high display contrast of approximately 400 to 600. Furthermore, the liquid crystal display device 1 of the present example was higher in response speed than was the liquid crystal display device 1 of Example 2 described below.

Also in the present example, as a result of studies with appropriate variations in the birefringence index Δn and cell thickness d (μm) of the liquid crystal molecules 300L, it was found that more sufficiently reduced mixture of colors in an oblique view and superior response speed are achieved in a case where the product (Δn×d) of the birefringence index Δn and the cell thickness d (μm) satisfies Formula (1) as follows:

$$( Δ n \times d ) < \frac{\sqrt{3}}{2} \times 0.55 \qquad ( 1 )$$

As a result of studies of a liquid crystal display device in which the first polarizing axis 510A and the second polarizing axis 520A were placed in directions differing by 90 degrees from those of the first polarizing axis 510A and the second polarizing axis 520A of Example 1-1, respectively, effects that are similar to those of Example 1-1 were brought about.

### Example 1-2

A liquid crystal display device 1 of Example 1-2 corresponding to Embodiment 1 was fabricated (see FIGS. 1 to 4). The liquid crystal display device 1 of the present example had the same configuration as that of Example 1-1 except that the twist pitch (p) between the liquid crystal molecules 300L brought into twist alignment by the chiral dopant was 24% of the cell thickness (d).

A relationship between the occurrence of display defects and driving voltages of the liquid crystal display device 1 of the present example was examined. Results are shown in Table 1. The presence or absence of the occurrence of display defects was determined according to whether a disclination line was found in a display area of the liquid crystal display device 1 when a predetermined voltage was applied between the first electrode 100E1 and the second electrode 100E2. In Table 1, “Poor” means that the appearance of a disclination line was visually confirmed, and “Good” means that the appearance of a disclination line was not visually confirmed.

A declination line is a line that appears due to a state of alignment of liquid crystal molecules and is visually recognized as a dark line in a normal display state. More disclination lines appear in some places than in others, and the appearance of a disclination line causes a decrease in luminance, undesirably resulting in the occurrence of display unevenness.

TABLE 1

| Driving voltage (%) | 70 | 75 | 85 | 90 | 95 | 100 |
|---|---|---|---|---|---|---|
| During increase | Good | Good | Good | Poor | Poor | Poor |
| in voltage | | | | | | |
| During decrease | Good | Poor | Poor | Poor | Poor | Poor |
| in voltage | | | | | | |

In Table 1 “Driving voltage (%)” denotes a voltage that is applied between the first electrode 100E1 and the second electrode 100E2 and a value obtained when a voltage at which the liquid crystal display device 1 reaches its maximum luminance (i.e. the maximum transmittance Tmax) is 100%. As shown in Table 1, during an increase in voltage, a disclination line was found when the driving voltage exceeded 85%. This is considered to be attributed to likelihood of reverse twist alignment in the presence of the application of a voltage between the first electrode 100E1 and the second electrode 100E2. Further, the occurrence of this defect has hysteresis. That is, during an increase in voltage, no disclination line was found until the driving voltage became 858; however, once a disclination line appeared, the disclination line needs to be erased by lowering the driving voltage to 70%. The reverse twist alignment is a state of alignment where the liquid crystal molecules 300L turns in a direction opposite to that in which they normally turn.

### Example 2

A liquid crystal display device 1 of Example 2 corresponding to the liquid crystal display device 1 of Embodiment 2 was fabricated (see FIGS. 1, 4, and 5). The liquid crystal display device 1 of the present example had the same configuration as that of Example 1-1 except that the liquid crystal molecules 300L had negative dielectric constant anisotropy and that the alignment process direction of the first alignment film 410 and the second alignment film 420 was different by 90 degrees from that of Example 1-1.

In the present example, in a plan view, the alignment direction 301LA of liquid crystal molecules 301L beside the first substrate 100 in the absence of the application of a voltage was placed orthogonal (specifically, at an angle of 90 degrees) to the longitudinal direction 100E2A of the openings 100E2X.

The liquid crystal display device 1 of the present example had reduced leakage of light, gave high display contrast, and also had sufficiently reduced mixture of colors in an oblique view. Further, the liquid crystal display device 1 of the present example exhibited higher transmittance than did the liquid crystal display device 1 of Example 1-1.

As a result of studies of a liquid crystal display device in which the first polarizing axis 510A and the second polarizing axis 520A were placed in directions differing by 90 degrees from those of the first polarizing axis 510A and the second polarizing axis 520A of Example 2, respectively, effects that are similar to those of Example 2 were brought about.

### Example 3

A liquid crystal display device 1 of Example 3 corresponding to the liquid crystal display device 1 of Embodiment 3 was fabricated (see FIGS. 1, 4, and 6). The liquid crystal display device 1 of the present example had the same configuration as that of Example 1-1 except that the pretilt angle of the liquid crystal molecules 301L beside the first substrate 100 in the absence of the application of a voltage was 2 to 3 degrees.

In the present example, the pretilt angle of the liquid crystal molecules 301L beside the first substrate 100 was adjusted to be 2 to 3 degrees by performing an alignment process on the first alignment film 140 by a rubbing method using a rubbing alignment film (e.g. an liquid crystal alignment material (SUNEVER) “SE” Series manufactured by Nissan Chemical Corporation). The alignment process performed on the second alignment film 240 is the same as that of Example 1-1.

The liquid crystal display device 1 of the present example had reduced leakage of light, gave high display contrast, and also had sufficiently reduced mixture of colors in an oblique view. Further, the liquid crystal display device 1 of the present example was slightly lower in transmittance than was the liquid crystal display device 1 of Example 1-1 but was higher in response speed than was the liquid crystal display device 1 of Example 1-1.

Substantially the same effects were brought about in both a case where the rubbing process was performed in a direction from top to bottom of FIG. 6 (to form a downward pretilt angle) and a case where the rubbing process was performed in a direction from bottom to top of FIG. 6 (to form an upward pretilt angle).

### Example 4

A liquid crystal display device 1 of Example 4 corresponding to the liquid crystal display device 1 of Embodiment 4 was fabricated (see FIGS. 1, 4, and 7). The liquid crystal display device 1 of the present example had the same configuration as that of Example 2 except that the pretilt angle of the liquid crystal molecules 301L beside the first substrate 100 in the absence of the application of a voltage was 2 to 3 degrees.

In the present example, the pretilt angle of the liquid crystal molecules 301L beside the first substrate 100 was adjusted to be 2 to 3 degrees by performing an alignment process on the first alignment film 140 by a rubbing method using a rubbing alignment film (e.g. an liquid crystal alignment material (SUNEVER) “SE” Series manufactured by Nissan Chemical Corporation). The alignment process performed on the second alignment film 240 is the same as that of Example 2.

The liquid crystal display device 1 of the present example had reduced leakage of light, gave high display contrast, and also had sufficiently reduced mixture of colors in an oblique view. Further, the liquid crystal display device 1 of the present example was slightly lower in transmittance than was the liquid crystal display device 1 of Example 2 but was higher in response speed than was the liquid crystal display device 1 of Example 2.

Substantially the same effects were brought about in both a case where the rubbing process was performed in a direction from top to bottom of FIG. 7 (to form a downward pretilt angle) and a case where the rubbing process was performed in a direction from bottom to top of FIG. 7 (to form an upward pretilt angle).

The foregoing has described embodiments of the present disclosure and modifications thereof; however, the present disclosure is not limited to the embodiments and the modifications thereof but can be carried out in various aspects and modifications thereof without departing from the scope of the present disclosure. Further, a plurality of constituent elements disclosed in the embodiments and the modifications thereof can be altered as appropriate. For example, one of all constituent elements shown in an embodiment or modification may be added as a constituent element of another embodiment or modification, or some of all constituent elements shown in an embodiment or modification may be deleted from the embodiment or modification.

Further, the drawings mostly schematically show each constituent element to facilitate understanding of the disclosure, and the thickness, length, number, spacing, or other attributes of each constituent element may be different from actual ones for the convenience of preparation of the drawings. Further, a configuration of each constituent element shown in the foregoing embodiments is merely an example and is not limited in particular, and various changes can be made without substantially departing from the effects of the present disclosure.

Embodiments of the present disclosure provide solutions described in the following items.

### [Item 1]

A liquid crystal display device having a plurality of picture elements arranged in a matrix including a plurality of rows and a plurality of columns, the liquid crystal display device comprising:
a first substrate;
a liquid crystal layer; and
a second substrate,
wherein
the first substrate, the liquid crystal layer, and the second substrate are arranged in this order from a back side toward a viewing screen side,
the first substrate includes a first electrode, an insulating layer, and a second electrode in which elongated openings extending along a row direction or a column direction of the plurality of picture elements are provided separately for each of the picture elements,
the first electrode, the insulating layer, and the second electrode are arranged in this order from the back side toward the viewing screen side,
the first substrate further includes a plurality of non-linear elements placed separately in correspondence with each of the picture elements,
the liquid crystal layer contains liquid crystal molecules and a chiral dopant, and
in a plan view, an alignment direction of the liquid crystal molecules beside the first substrate in absence of application of a voltage is placed parallel or orthogonal to a longitudinal direction of the openings.

### [Item 2]

The liquid crystal display device according to Item 1, wherein
the liquid crystal molecules have positive dielectric constant anisotropy,
in a plan view, the alignment direction of the liquid crystal molecules beside the first substrate in the absence of the application of a voltage is placed parallel to the longitudinal direction of the openings.

### [Item 3]

The liquid crystal display device according to Item 1, wherein
the liquid crystal molecules have negative dielectric constant anisotropy,
in a plan view, the alignment direction of the liquid crystal molecules beside the first substrate in the absence of the application of a voltage is placed orthogonal to the longitudinal direction of the openings.

### [Item 4]

The liquid crystal display device according to any one of Items 1 to 3, wherein the liquid crystal layer has a thickness greater than or equal to 5% and less than 25% of a twist pitch between the liquid crystal molecules brought into twist alignment by the chiral dopant.

### [Item 5]

The liquid crystal display device according to any one of Items 1 to 4, wherein in a plan view, an alignment direction of the liquid crystal molecules beside the second substrate in the absence of the application of a voltage is parallel to the alignment direction of the liquid crystal molecules beside the first substrate in the absence of the application of a voltage.

### [Item 6]

The liquid crystal display device according to any one of Items 1 to 5, wherein
a product (Δn×d) of a birefringence index Δn of the liquid crystal molecules and a thickness d (μm) of the liquid crystal layer satisfies a relational expression expressed by Formula (1) as follows:

$$( Δ n \times d ) < \frac{\sqrt{3}}{2} \times 0 \text{.55} , \qquad ( 1 )$$

and
a voltage that is applied between the first electrode and the second electrode is driven at 85% or lower of a voltage at which the liquid crystal display device gives a maximum luminance.

### [Item 7]

The liquid crystal display device according to any one of Items 1 to 6, wherein
a pretilt angle of the liquid crystal molecules beside the first substrate in the absence of the application of a voltage is larger than or equal to 1 degree and smaller than or equal to 5 degrees with respect to a principal surface of the first substrate, and
a pretilt angle of the liquid crystal molecules beside the second substrate in the absence of the application of a voltage is substantially 0 degree with respect to a principal surface of the second substrate.

### [Item 8]

The liquid crystal display device according to any one of Items 1 to 7, wherein the first substrate further includes a color filter layer and a planarizing film placed at a side of the color filter layer that faces the liquid crystal layer.

### [Item 9]

The liquid crystal display device according to any one of Items 1 to 8, wherein
the first substrate further includes an elongated light-shielding film placed between the plurality of picture elements, and
in a plan view, a longitudinal direction of the light-shielding film is placed parallel to the longitudinal direction of the openings.

### [Item 10]

The liquid crystal display device according to any one of Items 1 to 9, further comprising:
a first polarizing plate having a first polarizing axis; and
a second polarizing plate having a second polarizing axis,
wherein
the first polarizing plate is placed at a back side of the first substrate,
the second polarizing plate is placed at a viewing screen side of the second substrate,
the first polarizing plate and the second polarizing plate are placed such that the first polarizing axis and the second polarizing axis are orthogonal to each other, and
in a plan view, the second polarizing axis is placed parallel or orthogonal to the longitudinal direction of the openings.

The present disclosure contains subject matter related to that disclosed in Japanese Priority Patent Application JP 2024-229210 filed in the Japan Patent Office on Dec. 25, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device having a plurality of picture elements arranged in a matrix including a plurality of rows and a plurality of columns, the liquid crystal display device comprising:
a first substrate;
a liquid crystal layer; and
a second substrate,
wherein
the first substrate, the liquid crystal layer, and the second substrate are arranged in this order from a back side toward a viewing screen side,
the first substrate includes a first electrode, an insulating layer, and a second electrode in which elongated openings extending along a row direction or a column direction of the plurality of picture elements are provided separately for each of the picture elements,
the first electrode, the insulating layer, and the second electrode are arranged in this order from the back side toward the viewing screen side,
the first substrate further includes a plurality of non-linear elements placed separately in correspondence with each of the picture elements,
the liquid crystal layer contains liquid crystal molecules and a chiral dopant, and
in a plan view, an alignment direction of the liquid crystal molecules beside the first substrate in absence of application of a voltage is placed parallel or orthogonal to a longitudinal direction of the openings.

2. The liquid crystal display device according to claim 1, wherein
the liquid crystal molecules have positive dielectric constant anisotropy,
in a plan view, the alignment direction of the liquid crystal molecules beside the first substrate in the absence of the application of a voltage is placed parallel to the longitudinal direction of the openings.

3. The liquid crystal display device according to claim 1, wherein
the liquid crystal molecules have negative dielectric constant anisotropy,
in a plan view, the alignment direction of the liquid crystal molecules beside the first substrate in the absence of the application of a voltage is placed orthogonal to the longitudinal direction of the openings.

4. The liquid crystal display device according to claim 1, wherein the liquid crystal layer has a thickness greater than or equal to 5% and less than 25% of a twist pitch between the liquid crystal molecules brought into twist alignment by the chiral dopant.

5. The liquid crystal display device according to claim 1, wherein in a plan view, an alignment direction of the liquid crystal molecules beside the second substrate in the absence of the application of a voltage is parallel to the alignment direction of the liquid crystal molecules beside the first substrate in the absence of the application of a voltage.

6. The liquid crystal display device according to claim 1, wherein
a product (Δn×d) of a birefringence index Δn of the liquid crystal molecules and a thickness d (μm) of the liquid crystal layer satisfies a relational expression expressed by Formula (1) as follows:
$$( Δ n \times d ) < \frac{\sqrt{3}}{2} \times 0 \text{.55} , \qquad ( 1 )$$
and
a voltage that is applied between the first electrode and the second electrode is driven at 85% or lower of a voltage at which the liquid crystal display device gives a maximum luminance.

7. The liquid crystal display device according to claim 1, wherein
a pretilt angle of the liquid crystal molecules beside the first substrate in the absence of the application of a voltage is larger than or equal to 1 degree and smaller than or equal to 5 degrees with respect to a principal surface of the first substrate, and
a pretilt angle of the liquid crystal molecules beside the second substrate in the absence of the application of a voltage is substantially 0 degree with respect to a principal surface of the second substrate.

8. The liquid crystal display device according to claim 1, wherein the first substrate further includes a color filter layer and a planarizing film placed at a side of the color filter layer that faces the liquid crystal layer.

9. The liquid crystal display device according to claim 1, wherein
the first substrate further includes an elongated light-shielding film placed between the plurality of picture elements, and
in a plan view, a longitudinal direction of the light-shielding film is placed parallel to the longitudinal direction of the openings.

10. The liquid crystal display device according to claim 1, further comprising:
a first polarizing plate having a first polarizing axis; and
a second polarizing plate having a second polarizing axis,
wherein
the first polarizing plate is placed at a back side of the first substrate,
the second polarizing plate is placed at a viewing screen side of the second substrate,
the first polarizing plate and the second polarizing plate are placed such that the first polarizing axis and the second polarizing axis are orthogonal to each other, and
in a plan view, the second polarizing axis is placed parallel or orthogonal to the longitudinal direction of the openings.
